(19) United States
(12) Patent Application Publication
(10) Pub. No.: US 2013/0124270 A1
(43) Pub. Date: May 16, 2013

(54) METHOD, DEVICE AND INTEGRATED SYSTEM FOR PAYMENT OF PARKING FEES

(71) Applicant: PARX Ltd, Rosh Pina (IL)

(72) Inventors: Ofer Tziperman, Shimsheet (IL); Arnon Efraty, Tel Aviv (IL)

(73) Assignee: PARX Ltd, Rosh Pina (IL)

(21) Appl. No.: 13/667,152

(22) Filed: Nov. 2, 2012

Related U.S. Application Data
(60) Provisional application No. 61/555,030, filed on Nov. 3, 2011.

(51) Int. Cl. G07B 15/02

(52) U.S. Cl. 705/13

(57) ABSTRACT

System and method for parking management including an in car device located in the vehicle. The in car device may include a transceiver a processing unit, an input device and a display. The in car device may receive instructions to initiate and terminate parking sessions and upon receiving such instruction to automatically communicate with an at least one parking management unit for exchanging information related to management of the parking session. Parking management units may include single space parking meters, multi space parking meters, parking occupancy meters, parking back end systems, parking back end servers and gates of parking garages.

### CROSS REFERENCE TO RELATED APPLICATIONS

This Application claims the benefit of U.S. Provisional Application Ser. No. 61/555,030, filed Nov. 3, 2011, which is hereby incorporated by reference in its entirety.

### FIELD OF THE INVENTION

The present invention is in the field of parking management. More particularly, the present invention is in the technical field of collecting parking fees including the enforcement of such payments.

### BACKGROUND OF THE INVENTION

Conventional means of payment of parking fees include various types of parking meters such as single space parking meters, multi space parking meters, also known as “Pay & Display systems” and the more advanced payment systems recently introduced such as personal parking meters, also referred to as “in car meters”, mobile telephone and smart phone payment systems.

Conventional means may be inconvenient for the motorist. Typically, when using single space or multi space parking meters the motorist usually has to decide in advance for how long parking time to pay. In case of a shorter parking period, the motorist cannot be refunded. In some cases he has to walk a long distance to the meter and back to his car. Using in car meters, the motorist is required for prepayment for future parking. Even the most advanced mobile phone and smart phone payment applications require tedious calls to a parking call center for activation and termination of parking, in which the motorist has to inform the call center about his parking location, city, street or zone. Many times the motorist doesn't know all these details. Using mobile phones for payment of parking fees typically involves high transaction costs and is very time consuming and expensive to enforce.

### SUMMARY OF THE INVENTION

According to embodiments of the present invention, there is provided an in-car device for parking management. The device may include a transceiver; a processor; and a computer usable or computer readable storage medium connected to the processor. The computer readable storage medium contains a set of instructions for parking management. When executed the processor may be configured to receive instructions to initiate and to terminate a parking session; and automatically communicate with a selected parking management unit for exchanging information related to management of the parking session when initiating and terminating said parking session.

Furthermore, according to embodiments of the present invention, the selected parking management unit may include: single space parking meters, multi space parking meters, parking occupancy meters, parking back end systems, parking back end servers, gates and automatic payment machines of parking garages.

Furthermore, according to embodiments of the present invention, communication with the selected parking management unit may be performed directly and or via a communication gateway.

Furthermore, according to embodiments of the present invention, communication with the selected parking management unit may be performed directly and or via a communication router.

Furthermore, according to embodiments of the present invention, the in car device may include a display to display a valid or invalid parking indication.

Furthermore, according to embodiments of the present invention, the in car device may include a contactless interface to communicate with short-range contactless smart card reader for exchanging information related to inspection of the parking session.

Furthermore, according to embodiments of the present invention, the in car device may include an in car parking meter.

Furthermore, according to embodiments of the present invention, the in car device may receive the instructions to initiate and terminate the parking session directly from a cell-phone.

Furthermore, according to embodiments of the present invention, the in car device may include may receive the instructions to initiate and terminate the parking session from a back end system and wherein the in car device to give indication of valid or invalid parking.

Furthermore, according to embodiments of the present invention, the in car device may be implemented on the vehicle's Trip Computer.

According to embodiments of the present invention, there is provided method for parking management, the method may include receiving at an in car device instructions to initiate and to terminate a parking session; and automatically communicating by the in car device with a selected parking management unit for exchanging information related to management of the parking session when initiating and terminating said parking session.

Furthermore, according to embodiments of the present invention, the method may include displaying a valid or invalid parking indication by the in car device.

Furthermore, according to embodiments of the present invention, the method may include communicating by a contactless interface of the in car device with short-range contactless smart card reader for exchanging information related to inspection of the parking session.

Furthermore, according to embodiments of the present invention, the method may include calculating fees due by an in car parking meter.

Furthermore, according to embodiments of the present invention, the instructions to initiate and terminate the parking session may be received directly from a cell-phone.

Furthermore, according to embodiments of the present invention, instructions to initiate and terminate the parking session may be received from a back end system and wherein the in car device to give indication of valid or invalid parking.

Furthermore, according to embodiments of the present invention, communicating by the in car device with a selected parking management unit may include detecting the relevant parking management unit; establishing a communication channel with the relevant parking management unit; sending a request to start the parking session; receiving parking validity confirmation; and sending a request to terminate the parking session.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a high-level diagram of an integrated system for parking management according to embodiments of the present invention;

FIG. 2 is a high-level diagram of an in car device according to embodiments of the present invention; and

FIG. 3 is a flowchart illustration of a method for parking management according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

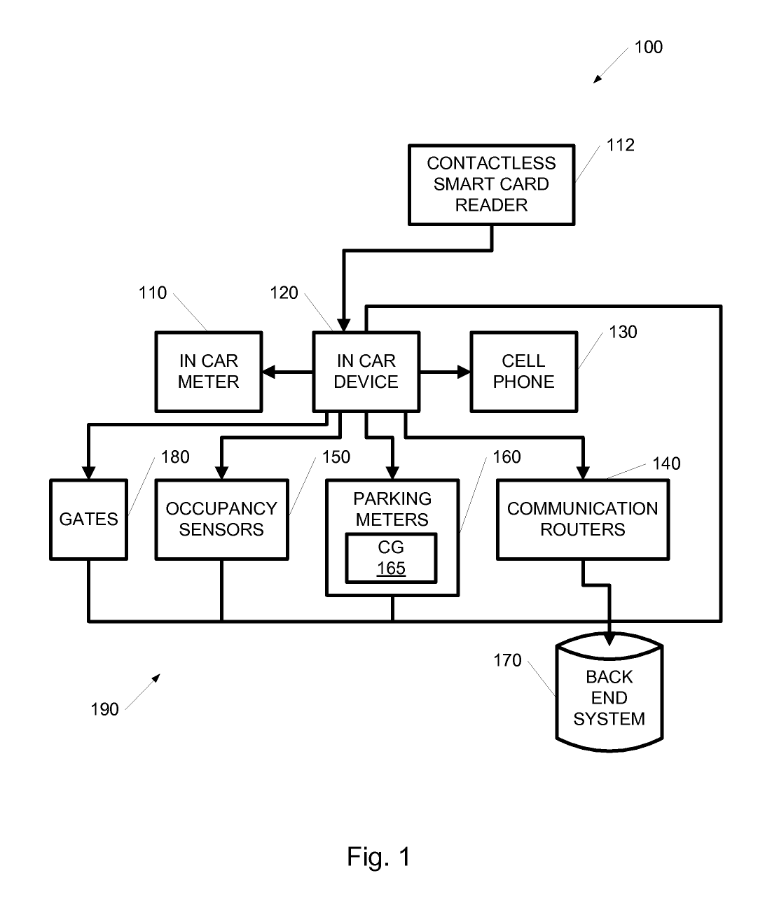

Reference is made to FIG. 1 which is a high-level diagram of an integrated system 100 for parking management according to embodiments of the present invention. According to embodiments of the present invention, system 100 may include an in car device 120, which is a device suitable for use on board any kind of vehicle. In car device 120 may be located in the vehicle. In car device 120 (or processor 220 within the device) may receive instructions to initiate and to terminate parking sessions from a motorist, and may automatically communicate with at least one parking management unit 190 for exchanging information related to management of the parking sessions. As used herein, parking management unit 190 may include any device or system that is adapted to manage or to take part in managing parking sessions, including, inter alia, permitting or prohibiting parking, giving parking confirmations, handling parking fees payment, billing and enforcing of parking rules etc.

In car device 120 may be configured to communicate with parking management units 190 such as single space and multi space parking meters 160, parking occupancy sensors 150, parking back end system 170 and parking lot gates and automatic payment machines of parking garages 180. In car device 120 may be configured to communicate with the parking management units 190 using any short range, variable range or long range, known or propriety communication protocols and interfaces as may be required. For example, in car device 120 may be configured to communicate with parking management units 190 over any applicable frequency range using any applicable communication protocol such as Bluetooth, near field communication (NFC), Wi-Fi communication protocols, etc. In car device may include, or be in communication with an in car meter 110.

In car device 120 may receive an instruction to initiate a parking session, for example, from a motorist. The instruction may be received directly from the motorist using input device of in car device 120, or indirectly, for example, via a portable mobile communication device such as handheld device or cellular telephone 130 of the motorist or via parking back end system 170. According to some embodiments, in car device 120 may receive an instruction to initiate a parking session from occupancy sensor 150, if occupancy sensor 150 senses that the vehicle has parked.

Upon receiving an instruction to initiate parking, in car device 120 may automatically communicate with a selected parking management unit to initiate a parking session. As used herein, selected parking management unit may relate to the parking management unit 190 that manages parking in the parking spot or area in which the user has parked or intends to park shortly and with which in car device communicates in order to manage the parking session. The selected parking management unit 190 may be, for example, the single space parking meter related to, or associated with the parking spot in which the user has parked his car, a multi space parking meter covering the area in which the user has parked his car, a parking occupancy sensor 150 and back end system 170. It is possible that more than one selected parking management units may be provided for a single parking spot. For example, a single parking spot may be connected to a multi space parking meter 160 and at the same time to a parking back end system 170 and/or to a parking occupancy sensor 150. In such cases, in car device 120 may select with which selected parking management unit to communicate based on various criteria such as link quality, lowest parking rates etc.

In car device 120 may automatically detect, identify and establish a communication channel with the selected parking management unit 190 using any known or propriety protocol. For example, upon receiving an instruction to initiate parking, in car device 120 may broadcast inquiry massages on communication channels dedicated to parking management units 190, calling for a selected parking management unit and requesting to initiate a parking session. In car device 120 may identify the selected parking management unit 190 based on the responses received from the selected parking management unit 190. Additionally or alternatively, parking management units 190 may periodically broadcast beacon massages informing of their availability. In car device 120 may scan communication channels dedicated to parking management units 190 to identify the relevant parking management unit. After the selected parking management unit is identified, a communication channel may be established.

The location of the parking vehicle may be either entered manually by the user or determined automatically using various location identifying methods as known in the art. The accuracy of the determined parking location may vary depending on the location identifying method used. Optionally, the location of the parking vehicle may be determined using occupancy sensor 150, for example, as described in U.S. patent application Ser. No. 13/386,824 filed on Jan. 24, 2012 to the applicant of the present application, and entitled “FULLY AUTOMATED PARKING SYSTEM”, which is incorporated in its entirety herein by reference. Proper parking fee rate may be assigned for the parking session based on the known location of the parking spot. Occupancy sensors 150 may give a very accurate and specific indication of the location of the parking spot while other triangulation methods may give an estimate of the general area in which the vehicle has parked.

When establishing a parking session, in car device 120 may send a request to the selected parking management unit to start parking session, including data related to the parking session. The data may include, inter alia: in car device ID, which may either correspond or not with the vehicle's license plate number, time when the parking event has started, and if known, time when the parking will terminate. In car device 120 may receive back from the selected parking management unit a response including parking validity confirmation, suggesting whether parking is valid or invalid and/or whether payment is confirmed. When parking validity or payment is confirmed by the relevant parking management unit, in car device 120 may give indication to the motorist as well as to the parking officer that the parking is valid and/or that payment was made and approved.

To terminate parking, the motorist may give in car device 120 an instruction to terminate parking. Upon receiving such instruction, in car device may communicate with the selected parking management unit to terminate the parking session. For example, in car device 120 may send the selected parking management unit a request to terminate the parking session. Termination of the parking session may include calculation and billing of the payment due, if this was not done before.

In car device 120 may be also used for “off street” parking, e.g., parking garages, both gated and non-gated. When used for payment in parking garages in car device 120 may communicate with gates 180 and other parking management units of the parking garages such as automatic payment machines, to initiate opening and closing of gates 180 as well as to collect payment of the parking bill.

Once the payment due is determined, payment for “on street” or “off street” parking may be performed in any applicable method. For example, the parking fees may be deducted from a prepaid bank preloaded to in car device 120, or may be credited to an account of a credit card umber that was related to in car device 120 during a registration process. In a non gated “off street” embodiment in car device 120 may be used for payment of parking fees either in conjunction with a parking meters 160 such as a “Pay and display” or “Pay on foot” or as a stand alone independent payment device based on prepaid bank of in car device 120 or credit card account.

In car device 120 may include or be in communication with an in car parking meter (PPM) 110. In car parking meter 110 may be used for paying parking fees, as known in the art. In car device 120 may add communication capabilities to in car parking meter 110. For example, in car device 120 may inform the selected parking management unit that payment is performed via in car parking meter 110. According to some embodiments, in car device 120 may receive information regarding current parking rates and rules from the selected parking management unit and update the database of in car parking meter 110. Additionally or alternatively, in car device 120 may initiate parking session of in car parking meter 110 only upon receiving a valid parking confirmation from the relevant parking unit.

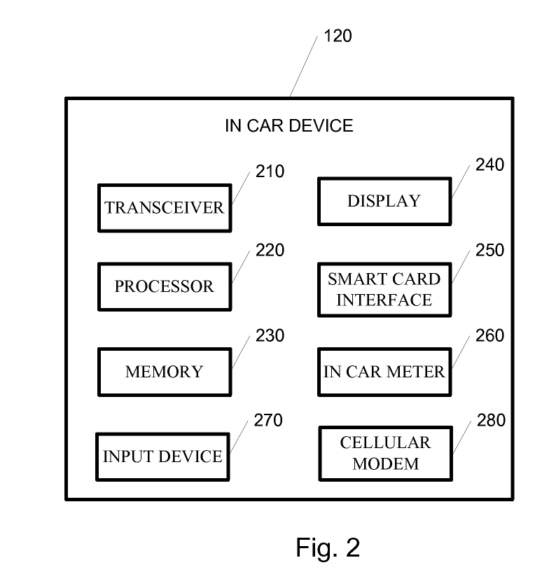

In car device 120 may be interrogated by a parking officer using communication means such as cellular phones, mobile terminal or dedicated devices on whether a particular motorist has paid his parking fees or whether the parking session is valid. For example, the parking officer may use short-range contactless smart card reader 112 to communicate with a contactless interface 250 (shown in FIG. 2) of in car device 120. According to some embodiments of the present invention, a parking officer may communicate directly with in car device 120 to securely retrieve parking validity info while authenticating in car device 120 itself.

To manage parking sessions, in car device 120 may be in active communication with a parking meter 160 via a communication gateway 165. Communication gateway 165 may typically be installed within parking meter 160. Communication gateway 165 may have its own power supply or it may draw power from parking meter 160. Communication gateway 165 may exchange data with parking meter 160, as will be explained in detail hereinbelow, according to any applicable, known or propriety communication protocol, parallel, serial, wireless or any other communication port or interface. Communication gateway 165 may receive from in car device 120 some or all of the following data: identification number (ID) of in car device 120, and/or vehicle license plate number (LPN), time of parking session start and/or time of parking session termination. Communication gateway 165 may forward the received data to parking meter 160 and receive from parking meter 160 a confirmation message indicating whether parking is approved and valid. Communication gateway 165 may send this confirmation message to in car device 120 causing in car device 120 to give indication that the parking is valid and/or that payment was made and approved.

In car device 120 may be in active communication with communication routers 140. Communication routers 140 may be located in the proximity of parking areas and may interconnect the various entities of system 100. Communication routers 140 may be used to increase the area covered by system 100 to places that are not covered by parking meters 160. For example, if the vehicle is parked in an area that is not covered by parking meters 160, in car device 120 may communicate with distant parking meters 160 or directly with back end system 170 to manage parking sessions, via communication routers 140. In addition, communication routers 140 may assist in identifying the location of the parked vehicle and increase the accuracy of the location data measured by system 100. Communication routers 140 may typically include power supply e.g. battery with solar panels for recharge or connection to the mains power supply, a transceiver for communicating, for example, with parking management units 190 and in car device 120, a long range transceiver such as cellular modem or Wi-Fi interface for communicating, for example, with parking management units 190 and back end system 170. According to some embodiments of the present invention, in car device 120 may communicate the relevant parking management unit, e.g., with distant parking meters 160 or directly with back end system 170 using an in vehicle cellular modem 280 (shown in FIG. 2). In vehicle cellular modem 280 may be either embedded within or separate from but in active communication with in car device 120.

Back end system 170 may reside on a main back end server or a plurality of back end servers and may be configured to perform the functions related to parking management as listed hereinbelow:

Registration—in car device 120 may be registered to system 100 by performing registration process which records the motorist's details in a users registry in back end system 170. For example, in car device 120 may be registered prior to its first use for parking management. A single in car device may be registered as associated with a specific one or more vehicle license plate numbers (LPN). Registration data may also include selected means of payment such as credit cards or interbank payment and indication whether parking fees are pre-paid or post paid. Registration data may also include other items such as the user personal identification number, address, phone number, etc. As may be required.

Confirmation—initiation and termination of parking messages may be sent to back end system 170 from either in car device 120 or other parking management units 190 such as parking meters 160, communication routers 140 and handheld device 130. A request to initiate parking may be checked by back end system 170 for eligibility in terms of availability of funds and customer status. If and when approved, a proper message may be sent back to in car device 120 and to the other parking management units 190.

Billing—back end system 170 may handle the billing of the motorist for parking sessions made. Billing may be made every agreed period of time (every month, quarter etc.).

Enforcement—back end system 170 may be interrogated by a parking officer using communication means such as cellular phones or dedicated devices on whether a particular motorist has paid his parking fees or whether the parking session is valid.

Reference is made to FIG. 2 which is a high-level schematic diagram of in car device 120 according to embodiments of the present invention. In car device 120 may be implemented using any suitable combination of memory 230, hardwired logic, and/or general-purpose or special-purpose processor or controller 220, as is known in the art. Transceiver module 210 may provide several communication channels over any applicable frequency range using any propriety or standard communication protocols such as Bluetooth, NFC, Infrared Data Association (IrDA) communication protocols, Wi-Fi etc. A contactless smart card interface 250 may enable communication with short-range contactless smart card reader for exchanging information related, for example, to inspection of parking sessions. In car device 120 may include a display 240 to display a valid or invalid parking indication. For example, display 240 may include one or more light emitting diodes (LED's) that may signal both the motorist as well as the parking officer that parking is valid or that payment was made and approved. Additionally or alternatively, display 240 may include a screen or a touch screen such as liquid crystal display (LCD) for indicating valid or invalid parking as well as other information pertinent to the parking session including but not limited to parking zone, corresponding parking meter 160 number, rates, maximum parking time limitations etc. In addition, display 240 may optionally display a special security code that may increase the level of security of in car device 120 and prevent the use of counterfeited equipment. In car device 120 may include an in car parking meter 260 that may be activated when parking is initiated and terminated when parking ends.

In car device 120 may include an input device 270 for receiving instructions form the motorist. The input device may include discrete input means, such as buttons, to enable initiating and terminating of parking, or any other suitable input means such as a touch screen.

According to some embodiments of the present invention in car device 120 may be a stand alone device dedicated for parking management. Alternatively, in car device 120 may be embedded as an added functionality to assemblies and infrastructures already present in the vehicle such as the vehicle's trip computer. In some embodiments of the present invention, in car device 120 may be embedded in a handheld device of the motorist, for example, in car device 120 may be implemented as a smart phone application.

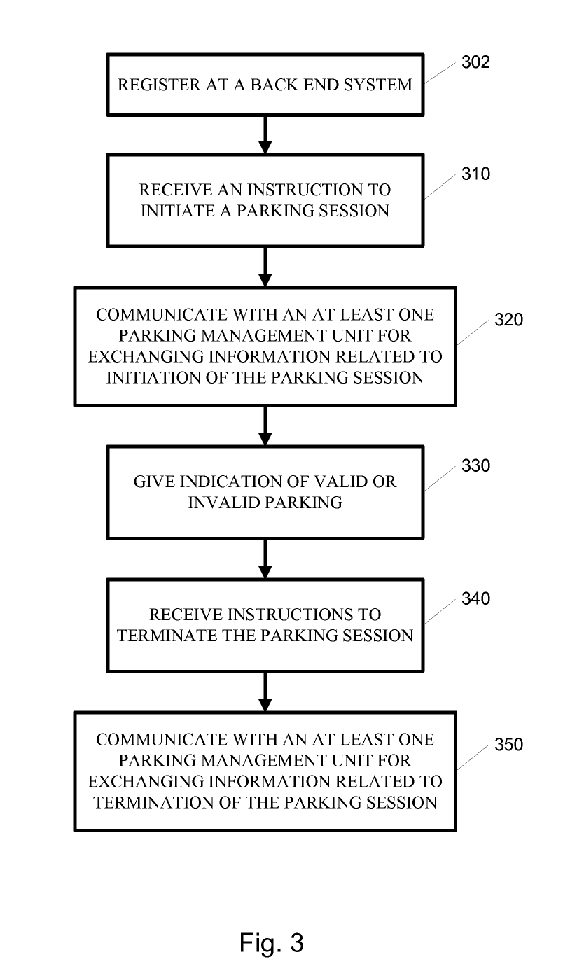

Reference is now made to FIG. 3 which is a flowchart illustration of a method for parking management according to embodiments of the present invention. According to embodiments of the present invention, the method for parking management may be performed by a system for parking management such as, for example, system 100 depicted in FIG. 1.

In an optional preliminary step 302, in car device 120 may be required to register at back end system 170 prior to being allowed to initiate parking sessions. When registered, in car device 120 may be associated with a specific one or more vehicle license plate numbers, as well as with proper means of payment such as credit cards or interbank payment. Alternatively, in car device 120 may be preloaded with a pre paid bank which may be used for paying parking fees and may eliminate the need for registration.

At block 310 in car device 120 may receive an instruction to initiate parking. The instruction may be received directly from the motorist using input device 270 of in car device 120, or indirectly, for example, via handheld device 130 of the user or via parking back end system 170. Upon receiving an instruction to initiate parking session, in car device 120 may automatically identify and communicate with the selected parking management unit 190 for exchanging information related to management of the parking session, as indicated in block 320. The information may include in car device ID, which may either correspond or not with the vehicle's license plate number, time when the parking session has started, and if known, time when the parking session will terminate. In car device 120 may receive back from the selected parking management unit a valid parking confirmation or payment confirmation. When parking or payment is confirmed by the relevant parking management unit, in car device 120 may give indication that the parking is valid and/or that payment was made and approved, as indicated in block 330. In block 340 in car device 120 may receive an instruction to terminate parking. The instruction to terminate parking may be received by similar means as the instruction to initiate parking. In block 350, in car device 120 may communicate with the selected parking management unit to terminate the parking session. Termination of the parking session may include calculation and billing of the payment due, if this was not done before.

According to some embodiments of the present invention, handheld device 130 may be used to initiate parking and payment, for example, by communicating directly with back end system 170. In this case handheld device 130 may use various communication technologies (Bluetooth, NFC, IR etc.) to communicate with in car device 120 so that in car device 120 may give a clear indication that parking is valid or that parking fees were properly settled. Alternatively, back end system 170 may communicate with in car device 120, via communication router 140 or directly using cellular modem 280, to deliver indication of valid or invalid parking. Termination of the parking session and ending of the payment process may be initiated either by handheld device 130 or by in car transponder 120, for example, in response to an instruction of the motorist.

It should be readily understood by those skilled in the art that initiation and termination of a parking session may be activated by other means than an explicit instruction from a motorist. For example, parking termination may be indicated by an accelerometer of the vehicle, by the parking occupancy sensor 150, or by a global positioning system (GPS) that may indicate that the vehicle has left the parking spot etc.

According to embodiments of the present invention, upon receiving an instruction to initiate and terminate a parking session in car device 120 automatically detects, identifies, establishes communication channel and exchanges information with the relevant parking management unit. Automatically communicating with the selected parking management unit eliminates the need to manually call back end system 170 as is required by the most advanced cellular telephone (cell phone) parking management and fee payment systems. This may make paying paring fees even easier for the motorist. Advantages of embodiments of the present invention include, without limitation, that it is easy to use and user friendly by avoiding the need to look for a parking meter, eliminate the need for cash, eliminate the need to go back to the vehicle and place the receipt. In addition the motorist will have to pay only for the time actually parked unlike most present “pay and display” parking meters technology that requires the driver to try and guess the time he plans to park taking the risk of overpaying (paying more than the actual time used) or underpaying and risking in getting a parking tickets. Additional advantages include facilitating the enforcement process, providing “Real time” occupancy information to both the motorist and an operator and allowing the motorist the use of a joint “off street” and “on street” payment facility.

Some embodiments of the present invention may be implemented in software for execution by a processor-based system, for example, in car device 120. For example, embodiments of the present invention may be implemented in code or software and may be stored on a non-transitory storage medium having stored thereon instructions which, when executed by a processor, cause the processor to perform methods as discussed herein, and can be used to program a system to perform the instructions. The non-transitory storage medium may include, but is not limited to, any type of disk including floppy disks, optical disks, compact disk read-only memories (CD-ROMs), rewritable compact disk (CD-RW), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices. Other implementations of embodiments of the present invention may comprise dedicated, custom, custom made or off the shelf hardware, firmware or a combination thereof.

Embodiments of the present invention may be realized by a system that may include components such as, but not limited to, a plurality of central processing units (CPU) or any other suitable multi-purpose or specific processors or controllers, a plurality of input units, a plurality of output units, a plurality of memory units, and a plurality of storage units. Such system may additionally include other suitable hardware components and/or software components.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An in-car device for parking management, the device comprising:
a transceiver;
a processor to:
receive instructions to initiate and to terminate a parking session; and
automatically communicate with a selected parking management unit for exchanging information related to management of the parking session when initiating and terminating said parking session.

2. The in-car device of claim 1 wherein the selected parking management unit is selected from the list consisting of: single space parking meters, multi space parking meters, parking occupancy meters, parking back end systems, parking back end servers, gates and automatic payment machines of parking garages.

3. The in-car device of claim 1 wherein communication with the selected parking management unit is performed via a communication gateway.

4. The in-car device of claim 1 wherein communication with the selected parking management unit is performed via a communication router.

5. The in-car device of claim 1 further comprising a display to display a valid or invalid parking indication.

6. The in-car device of claim 1 further comprising a contactless interface to communicate with short-range contactless smart card reader for exchanging information related to inspection of the parking session.

7. The in-car device of claim 1 further comprising an in car parking meter.

8. The in-car device of claim 1 wherein the in-car device is to receive the instructions to initiate and terminate the parking session directly from a cell-phone.

9. The in-car device of claim 1 wherein the in-car device is to receive the instructions to initiate and terminate the parking session from a back end system and wherein the in car device is to give an indication of valid or invalid parking.

10. The in-car device of claim 1 wherein the in-car device is implemented on a vehicle's trip computer.

11. A method for parking management, the method comprising:
receiving at an in car device instructions to initiate and to terminate a parking session; and
automatically communicating by the in car device with a selected parking management unit for exchanging information related to management of the parking session when initiating and terminating said parking session.

12. The method of claim 11 wherein the selected parking management unit is selected from the list consisting of: single space parking meters, multi space parking meters, parking occupancy meters, parking back end systems, parking back end servers, gates and automatic payment machines of parking garages.

13. The method of claim 11 wherein communicating with the selected parking management unit is performed via a communication gateway.

14. The method of claim 11 wherein communicating with the selected parking management unit is performed via a communication router.

15. The method of claim 11 further comprising displaying a valid or invalid parking indication by the in car device.

16. The method of claim 11 further comprising communicating by a contactless interface of the in car device with short-range contactless smart card reader for exchanging information related to inspection of the parking session.

17. The method of claim 11 further comprising calculating fees due by an in car parking meter.

18. The method of claim 11 wherein the instructions to initiate and terminate the parking session are received directly from a cell-phone.

19. The method of claim 11 wherein the instructions to initiate and terminate the parking session are received from a back end system and wherein the in car device to give indication of valid or invalid parking.

20. The method of claim 11 wherein communicating by the in car device with a selected parking management unit comprises:
detecting the relevant parking management unit;
establishing a communication channel with the relevant parking management unit;
sending a request to start the parking session;
receiving parking validity confirmation; and
sending a request to terminate the parking session.
